(19) United States
(12) Patent Application Publication
(10) Pub. No.: US 2018/0357819 A1
(43) Pub. Date: Dec. 13, 2018

(54) Method for generating a set of annotated images

(71) Applicant: FotoNation Limited, Galway (IE)

(72) Inventor: Florin OPREA, Bucharest (RO)

(21) Appl. No.: 15/621,848

(22) Filed: Jun. 13, 2017

(51) Int. Cl. G06T 17/10; G06T 15/04; G06K 9/00; G06T 19/20

(52) U.S. Cl. CPC G06T 17/10; G06T 15/04; G06K 9/00281; G06T 2219/004; G06K 9/00302; G06T 19/20; G06K 9/00288

(57) ABSTRACT

A method for generating a set of annotated images comprises acquiring a set of images of a subject, each acquired from a different point of view; and generating a 3D model of at least a portion of the subject, the 3D model comprising a set of mesh nodes defined by respective locations in 3D model space and a set of edges connecting pairs of mesh nodes as well as texture information for the surface of the model. A set of 2D renderings is generated from the 3D model, each rendering generated from a different point of view in 3D model space including providing with each rendering a mapping of x,y locations within each rendering to a respective 3D mesh node. A legacy detector is applied to each rendering to identify locations for a set of detector model points in each rendering. The locations for the set of detector model points in each rendering and the mapping of x,y locations provided with each rendering are analysed to determine a candidate 3D mesh node corresponding to each model point. A set of annotated images from the 3D model is then generated by adding meta-data to the images identifying respective x,y locations within the annotated images of respective model points.

### FIELD

The present invention relates to a method for generating a set of annotated images.

### BACKGROUND

Powerful machine learning approaches usually require huge amounts of high quality classified data. In the case of images including objects/subjects to be detected or recognized, classification can not only involve adding labels to an image, for example, indicating a male or female face, a laughing or frowning face, but also annotations identifying the location of features within an image, such as eyes, mouth, nose and even specific points within such features of a subject. Obtaining labeled/annotated data is one of the drawbacks to many machine learning algorithms, as annotation by manually marking features in images is time consuming and expensive.

### SUMMARY

According to the present invention there is provided a method for generating a set of annotated images according to claim 1.

The method is based on automatically annotating features of a 3D model based on statistically analyzing results for features detected by applying an “imperfect” detector, for example, a previous version of a classifier it is hoped to improve or replace, to 2D images generated from the 3D model.

So for example, a legacy multi-class detector could be applied to a set of images of a given model in an attempt to identify model points within each of the set of images. Once the features from the set of images are analyzed and mapped back to the 3D model, 2D annotated rendered images from the model can be used to train for example, a neural network based detector including a Z-output fully connected layer which can then replace what may have been a more cumbersome or less reliable legacy multi-class detector.

Embodiments can use annotated rendered images generated from realistic 3D models of human faces to provide, for example, an improved facial feature tracking detector.

Embodiments can use ideal conditions for acquiring the images to be used by the imperfect detector so that these can provide highly accurate sample renderings which can be used in determining associations between image features and 3D model nodes (vertices), so enabling automatic annotation of the 3D model.

### BRIEF DESCRIPTION OF THE DRAWINGS

An embodiment of the invention will now be described, by way of example, with reference to the accompanying drawings, in which:

FIG. 1 illustrates a process for generating a set of annotated images according to an embodiment of the present invention;

FIG. 2 illustrates the capturing of images of a subject within the process of FIG. 1;

FIG. 3 illustrates a 3D mesh produced within the process of FIG. 1;

FIG. 4 illustrates the classes of subject which can be detected by an exemplary multi-class detector employed within the process of FIG. 1;

FIG. 5 illustrates model points identified by a selection of classifiers employed by the multi-class detector employed within the process of FIG. 1;

FIG. 6 illustrates 2 views an of annotated 3D mesh generated within the process of FIG. 1;

FIG. 7 illustrates how custom backgrounds; adjustments to lighting settings; and/or addition of 3D objects may be made to the 3D mesh model of FIG. 1 prior to producing labelled/annotated images; and

FIG. 8 illustrates an exemplary annotated image produced according to the process of FIG. 1.

### DETAILED DESCRIPTION OF THE EMBODIMENTS

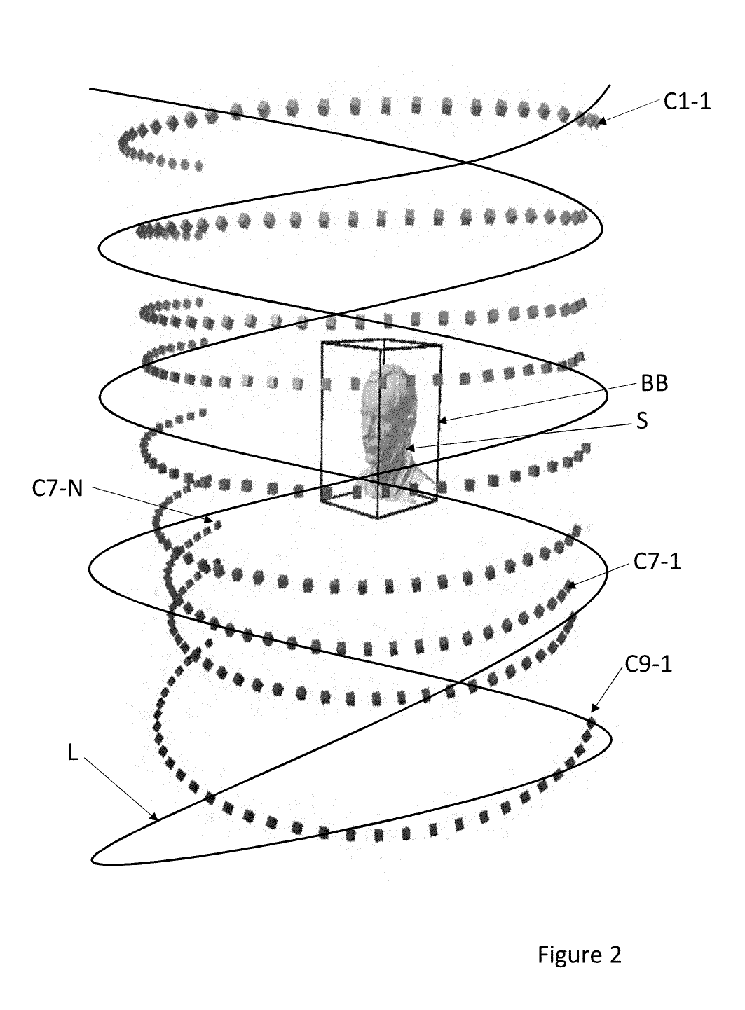

Referring first to FIG. 2, embodiments of the present application begin by generating a 3D model of a subject (S) using photogrammetry software such as provided by Agisoft PhotoScan from Agisoft LLC. Agisoft PhotoScan is a stand-alone software product that performs photogrammetric processing of digital images and generates 3D spatial data which can be used in many different forms of application.

It is well known to use such photogrammetry software to create a high quality 3D model which can be used to produce photo-realistic renderings of a subject. The process typically involves generating a set of images I_{C1-1} . . . I_{C9-N} of a (preferably) static subject S with one or more cameras. In some cases a set of cameras C1 . . . C9 can be mounted to a rig, in this case a vertical pole, and the rig rotated around the subject so that each camera can produce a number of images (1 . . . N) from different points of view relative to the subject. The acquired set of images I_{C1-1} . . . I_{C9-N} can comprise both visible (RGB) information as well as possibly near infra-red (NIR) information. Normally, the subject is placed with a plain background and is well lit from a number of angles to avoid shadowing to improve the modelling process. Typically about 300 images can be acquired for a given subject and labels can be added as metadata file for each image including for example, an identifier, gender, age, gesture, camera orientation etc.

Once the set of images has been acquired, the subject can be separated from any background, before the images are aligned. A bounding box (BB) for the subject (S) can then be defined either manually, semi-automatically or automatically based on knowledge of the type of subject. For example, it is possible to image a complete body with a head located in a known real space corresponding to the bounding box in model space.

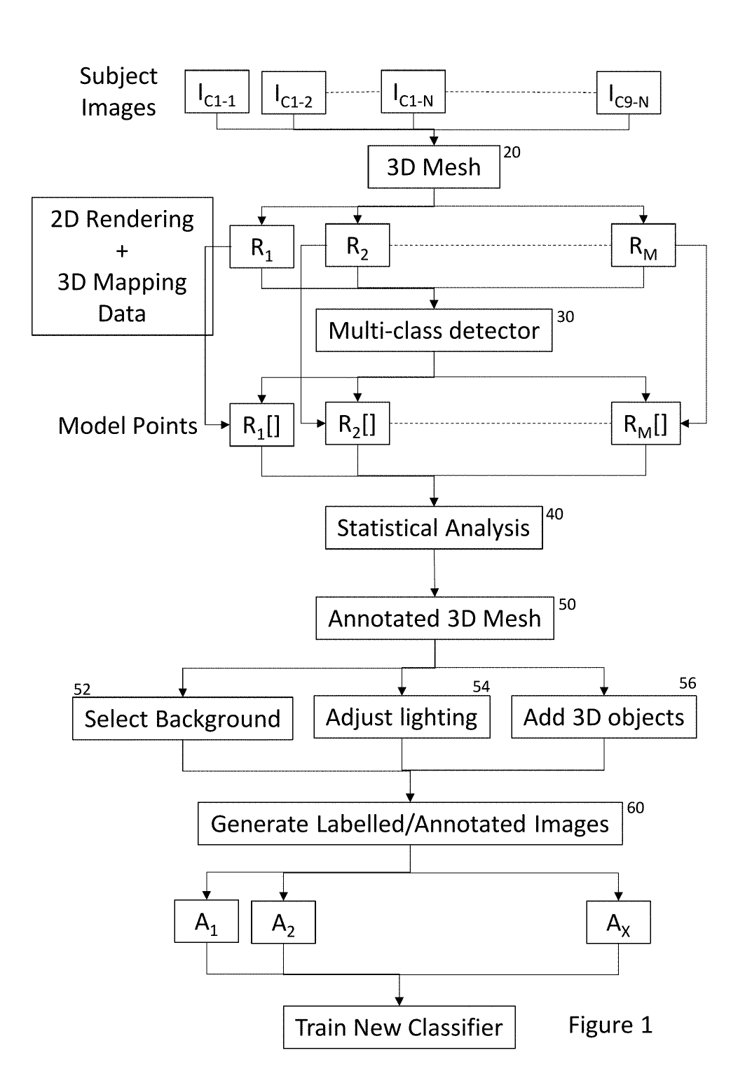

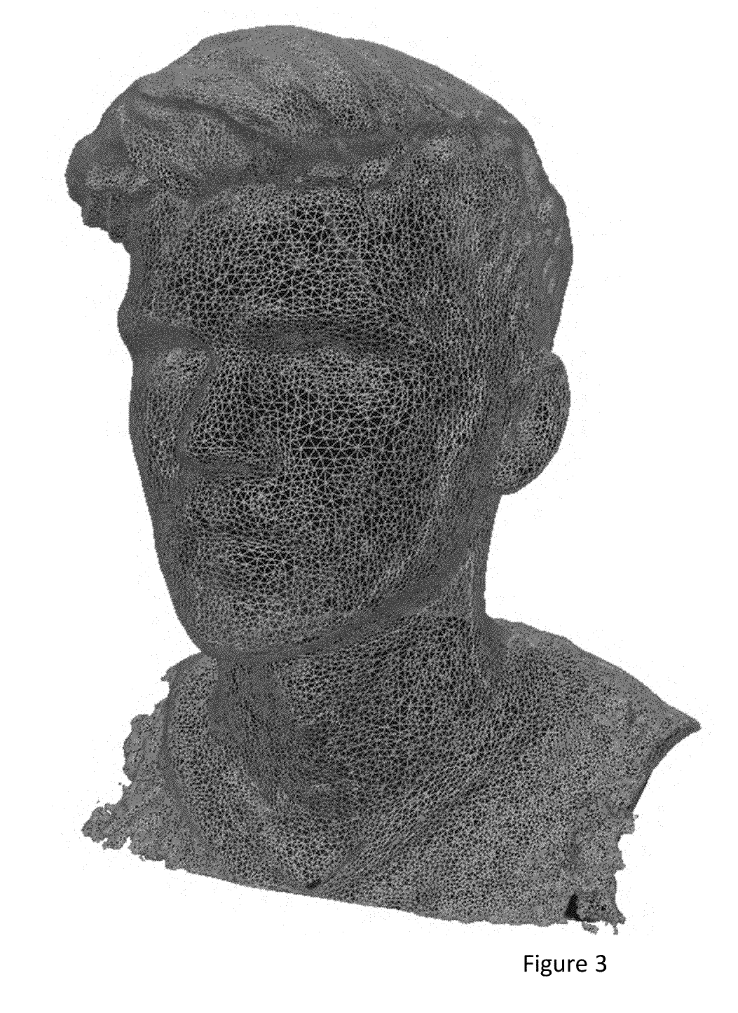

In any case, a point cloud identifying points on the surface of the subject within the bounding box can then be generated. Once the point cloud is complete, as indicated by step 20 of FIG. 1, a 3D mesh comprising a plurality of interlinked vertices can then be generated, for example, as shown in FIG. 3. Note that as well as the node coordinate and edge information illustrated for the model in FIG. 2, the mesh information also includes texture (visible and possibly NIR) information for the surface of the model.

Now with the 3D mesh produced according to the above process, it is possible to produce a number of photo-realistic 2D dimensional renderings R₁ . . . R_{M} from the 3D mesh. Note that the number of renderings M can differ from the number 9*N of original images used to generate the 3D mesh.

Unlike the original set of images captured by the cameras C1 . . . C9 however, embodiments of the present application provide with each generated rendering R₁, . . . R_{M}, a mapping connecting each two dimensional pixel location of the rendering with a 3D vertex of the 3D model. This mapping can comprise an association between the coordinates for each pixel (or small group of pixels) of the 2D rendering and a respective 3D mesh node identifier. Note that because of the non-linear shape of the 3D model, multiple 3D mesh nodes (vertices) can map to the same 2D pixel location and so the function mapping 3D node locations to 2D rendering pixel location is not bidirectional. Thus, it is not straightforward to add this data directly to the original images I_{C1-1} . . . I_{C9-N} and to use these instead of the renderings R₁ . . . R_{M} in the process of FIG. 1.

In the embodiment, each 2D rendering R₁ . . . R_{M} is produced by incrementally varying the pitch (rotation angle about a horizontal axis running through the subject) and yaw (rotation angle about a vertical axis running through the subject) of a point of view relative to the subject model.

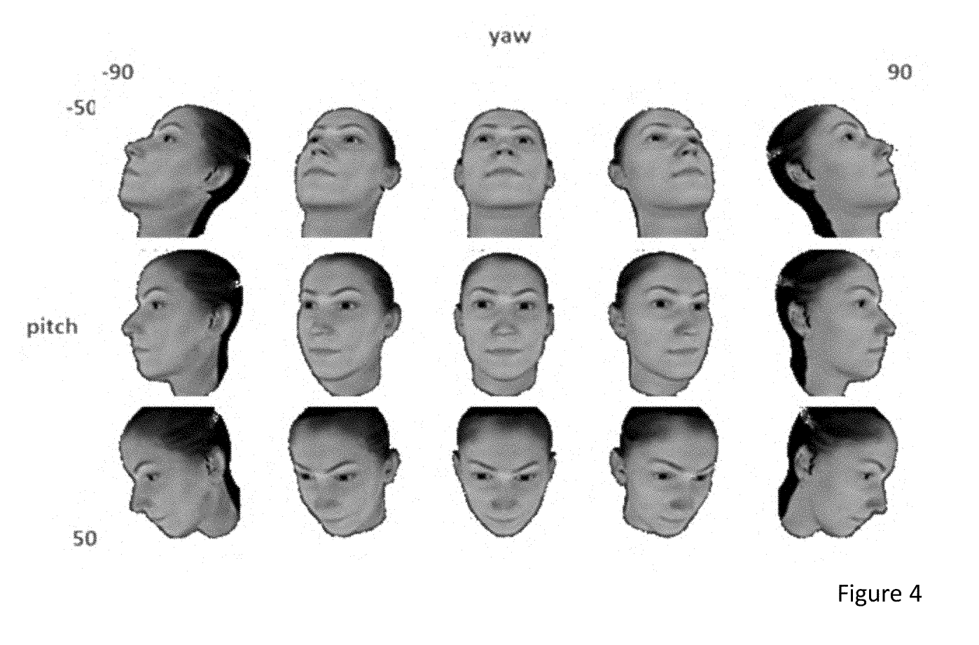

FIG. 4 shows the variation in the appearance of a subject produced by varying the yaw angle from −90 to 90 degrees and varying the pitch angle from −50 to 50 degrees around a subject.

Now an existing feature detector can be applied to each rendering R₁, . . . R_{M} to estimate the position of each feature detector model point in each rendering, step 30.

In the present embodiment, the feature detector comprises a number of discrete classifiers, each trained to detect a subject in a respective pose and each identifying a number of model points, in this case defining locations around the jaw, eyes, eyebrows, mouth, and nose of a subject. For example, there may be 15 classifiers, each trained to detect a subject in a respective one of the poses illustrated in FIG. 4. Of course this number can be increased or decreased according to the utility of providing such resolution, but a typical range would be between 15 and 35 classifiers.

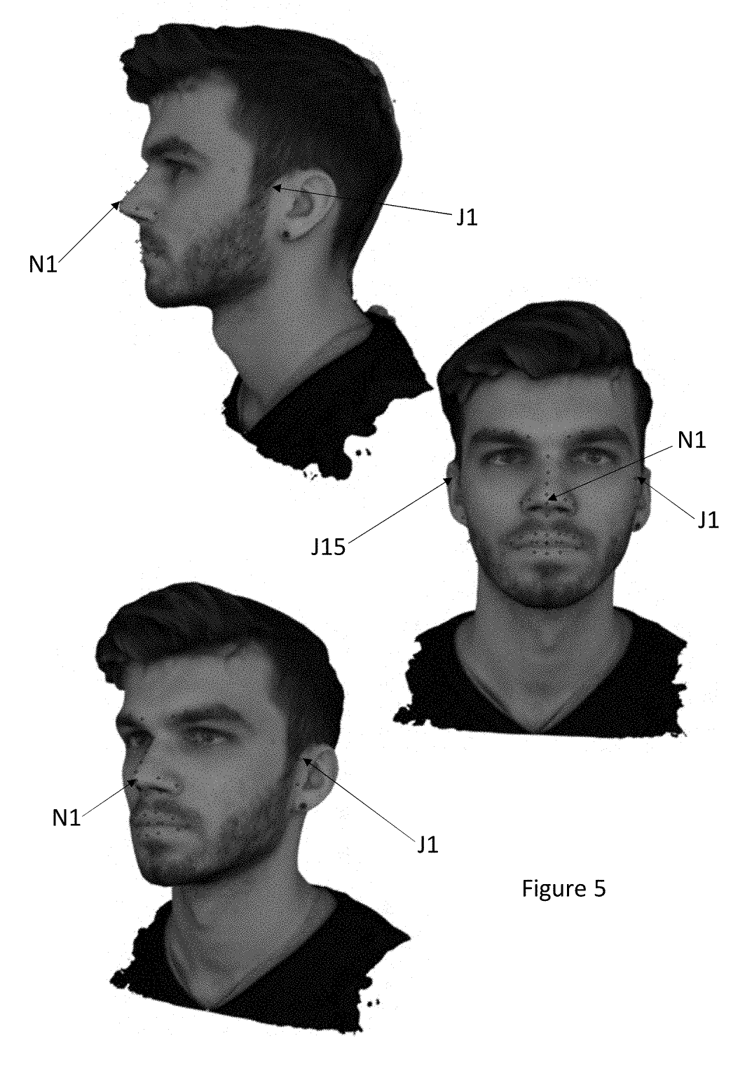

FIG. 5 illustrates subjects which can be detected by 3 such classifiers: a left profile face, frontal face and side face. As will be seen from the frontal face, each classifier may be able to locate a number of model points on the jaw, mouth, nose, eyes and eye brows of the subject. It will be seen how some model points such as N1 appear in subjects detected by a number of classifiers, whereas other points such as J15 or J1 may appear in subjects detected by a more limited number of classifiers than for example model points such as N1.

In one embodiment of the application, each of the renderings is included as a frame (or contiguous group of frames) in a video sequence with the point of view of the subject changing minimally or quasi-continuously from one rendering to the next. So for example, successive renderings might reflect a point of view travelling in a spiral around a subject between a maximum pitch/yaw and a minimum/pitch yaw so that subject poses corresponding to successive spatially adjacent classifiers of the multi-class detector 30 are rendered. An exemplary spiral is illustrated in FIG. 2 where it will be seen that the locus L defined by the spiral does not necessarily produce points of view which coincide with the original camera positions used to acquire images I_{C1-1} . . . I_{C9-N}.

The detector 30 can thus be implemented as a tracker first locating the subject within an initial rendering and then, as the point of view for each rendering changes, swapping from one classifier to a classifier for an adjacent pose in the matrix of classifiers such as illustrated in FIG. 4. This improves the chances of each classifier quickly picking up a subject and correctly identifying its model points in the rendering.

The results provided by the detector 30 comprise for each rendering a list of model point identifiers and associated x,y (pixel) locations within the rendering.

In the next step, a statistical analyser 40 uses the list of model point identifiers and their associated x,y pixel locations as well as the mapping data for each corresponding rendering R₁, . . . R_{M} to map model point identifiers for each rendering back to a node of the 3D mesh.

It will be seen that for some model points, there will be strong agreement from the application of various classifiers to the set of renderings on the 3D mesh node for a model point; whereas for other model points, more than one 3D mesh node may be suggested by the various classifiers, or only a limited amount of data may have been available for a given model point limiting the number of instances mapping the model point to a given 3D mesh node.

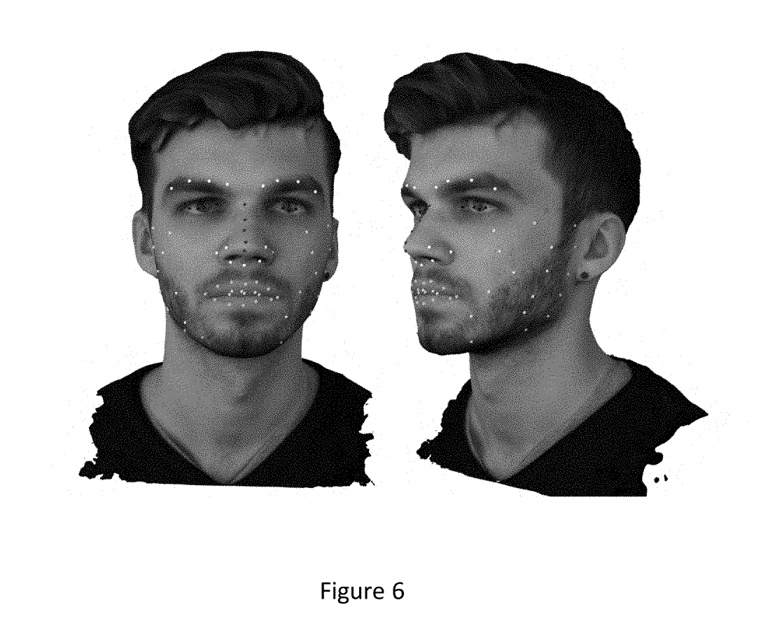

Referring now to FIG. 6, the model points can be displayed on the 3D mesh model (in this case also using showing surface texture) in association with their identified 3D mesh node. These can be presented in a number of different ways to distinguish those nodes where the process has a high confidence in the 3D mesh node determined for the model point and those where confidence is lower or dissipated across a number of 3D mesh nodes. So for example, model points can be presented in different colors where brighter colors indicate problem model points which may need to be manually moved and associated with a 3D mesh node. Larger indicators may be used to flag model points which have been mapped to a number of 3D mesh nodes. In other examples, an ordered table ranked according to the incidence of model points matching a specific 3D mesh node can be presented—those model points with low instances can be readily identified, selected and their position then manually adjusted.

The end result of this process is an annotated 3D mesh 50 such as illustrated in FIG. 6.

It will be seen that the process of using the acquired images I_{C1-1} . . . I_{C9-N} to generate the mesh 20, generating the renderings R₁ . . . R_{M}, applying the detector to the renderings to produce the model points R₁[ ] . . . R_{M}[ ] and performing the statistical analysis 40 of the model points and mapping data to produce the annotated mesh can be completely automated and that the process of manually adjusting the location of some of the model points can be relatively quick.

It is now possible to generate any number of 2D photorealistic renderings A₁ . . . Aₓ from the 3D mesh information 50, step 60.

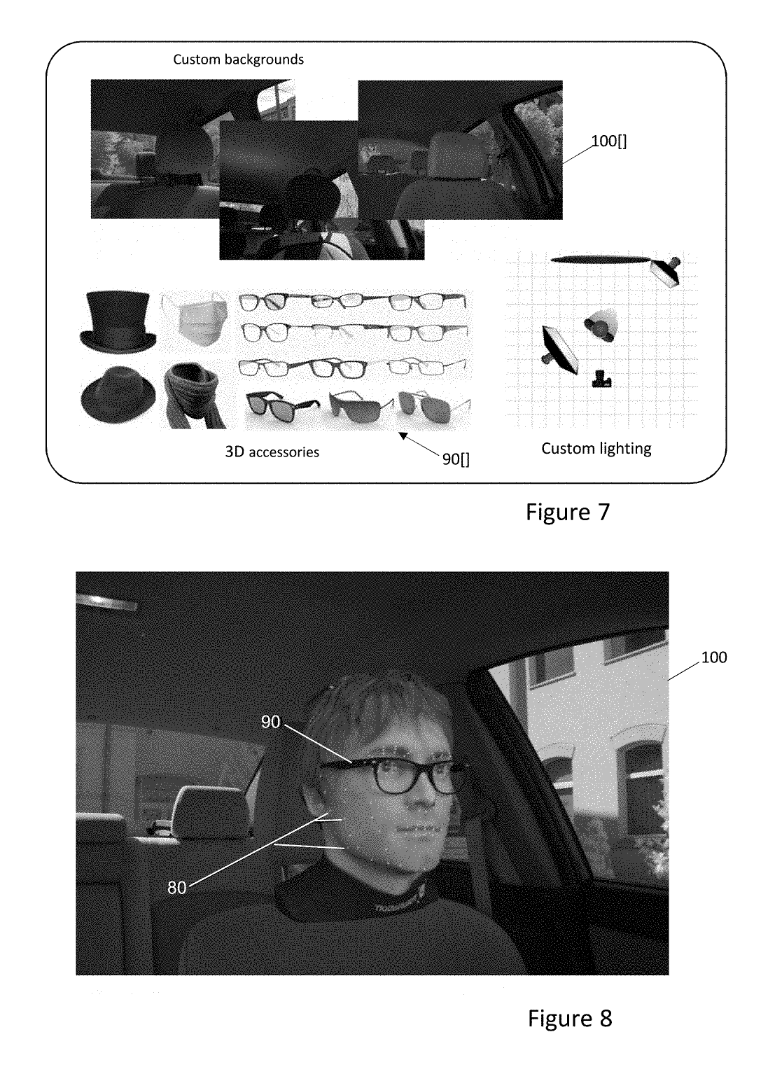

Before doing so however, it can be desirable to for example, select a background from a menu of backgrounds such as shown in FIG. 7, step 52, to adjust the lighting model which will be used in generating the various renderings A₁ . . . Aₓ, step 54, and possibly even select an accessory from a library 3D objects such as shown in FIG. 8 which can be added to the 3D model of the subject S.

Thus, in the example shown in FIG. 8, a 3D model of a pair of glasses 90 selected from a library of 3D accessories 90[ ] has been fitted over a subject head and the head superimposed on a background image 100 of a car interior selected from a library of images 100[ ] before providing the final rendering. In this case, the model points, some of which are indicated by the numeral 80, are illustrated for the rendering, but normally these would not be shown and would be appended as meta-data to the rendering as with the mapping data in the renderings R₁ . . . R_{M}.

Note that it is possible to also create different 3D scenes so that the lighting added to the scene can cast actual shadows on the 3D background objects (rather than no or unnatural shadows on a 2D background image, such as the image 100).

It will be appreciated that other post processing of the annotated 3D mesh 50 can also before performed before producing the renderings A₁, . . . Aₓ, for example, feature deformation, animation or texture adjustment.

The annotated renderings A₁ . . . Aₓ can either be produced as individual images in any known image format such as JPEG etc; or a sequence of renderings can be used to provide a synthesized video sequence, again with annotations saved as meta data.

As explained, the annotated renderings A₁ . . . Aₓ can now be used to train any new classifier as required.

1. A method for generating a set of annotated images comprising the steps of:
acquiring a set of images of a subject, each acquired from a different point of view;
generating a 3D model of at least a portion of the subject, the 3D model comprising a set of mesh nodes defined by respective locations in 3D model space and a set of edges connecting pairs of mesh nodes as well as texture information for the surface of said model;
generating a set of 2D renderings from said 3D model, each rendering generated from a different point of view in 3D model space including providing with each rendering a mapping of x,y locations within each rendering to a respective 3D mesh node;
applying at least one legacy detector to each rendering to identify locations for a set of detector model points in each rendering;
analyzing said locations for said set of detector model points in each rendering and said mapping of x,y locations provided with each rendering to determine a candidate 3D mesh node corresponding to each model point; and
generating a set of annotated images from said 3D model by adding meta-data to said images identifying respective x,y locations within said annotated images of respective model points.

2. A method according to claim 1 further comprising prior to said generating, adding a background to each of said set of annotated images.

3. A method according to claim 2 wherein said adding a background comprises adding one or more background objects in 3D model space.

4. A method according to claim 1 further comprising prior to said generating, adding one or more foreground objects in 3D model space.

5. A method according to claim 4 comprising fitting one or more of said foreground objects to said model of at least a portion of said subject in 3D model space.

6. A method according to claim 1 further comprising prior to said generating, defining one or more lighting sources in 3D model space.

7. A method according to claim 1 wherein said analyzing comprises correlating said candidate 3D mesh node locations corresponding to each model point generated from each rendering to determine candidate 3D mesh node locations with a high confidence level and 3D mesh node locations with a lower confidence level; and
displaying candidate 3D mesh node locations for said model points according to said confidence levels.

8. A method according to claim 7 further comprising responsive to user interaction with a candidate 3D mesh node location for a model point, adjusting a 3D mesh location for said candidate 3D mesh node location.

9. A method according to claim 1 wherein said generating a set of 2D renderings comprises generating a video sequence comprising said renderings.

10. A method according to claim 9 wherein said point of view continuously varies through said video sequence along a locus in 3D model space.

11. A method according to claim 10 wherein said locus is helical.

12. A method according to claim 10 wherein said legacy detector is a multi-class detector, each classifier within said detector being arranged to detect a subject in one of a number of different poses.

13. A method according to claim 12 comprising varying said point of view so that respective classifiers for spatially adjacent poses successively detect said subject during said video sequence.

14. A method according to claim 12 wherein said poses differ from one another in one of both pitch and yaw around horizontal and vertical axes within 3D model space.

15. A method according to claim 1 wherein said subject comprises a human head and wherein said legacy detector comprises a face detector, said model points comprising points on one or more of a human jaw, eyes, eye brows, nose or mouth.

16. A method according to claim 1 wherein said texture information comprises one or both of near infra-red intensity and visible color intensity information.

17. A computer program product comprising a computer readable medium on which instructions are stored which, when executed on a computer system, are configured for performing the steps of claim 1.
